(19) United States
(12) Patent Application Publication
(10) Pub. No.: US 2011/0313981 A1
(43) Pub. Date: Dec. 22, 2011

(54) Data Privacy, Redaction and Integrity for Relational Databases

(75) Inventor: Ron Ben-Natan, Lexington, MA (US)

(73) Assignee: INTERNATIONAL BUSINESS MACHINES CORPORATION, Armonk, NY (US)

(21) Appl. No.: 12/817,482

(22) Filed: Jun. 17, 2010

(51) Int. Cl. G06F 17/30

(52) U.S. Cl. 707/694; 707/E17.007

(57) ABSTRACT

A method, a data processing system, and a computer program product for protecting data in a database. A query to a database in a data processing system is received by a security mechanism in the data processing system that is external of the database. The query is converted to a modified query according to a security policy. The modified query is sent to the database, and a response to the modified query is returned.

### BACKGROUND

1. Field

The disclosure relates generally to data processing systems and, more specifically, to a method and apparatus for protecting data in a database in a data processing system.

2. Description of the Related Art

Increasing regulation and privacy requirements are forcing organizations to implement strict access and privacy policies. Since most data resides in data stores such as relational databases, much of the focus is on relational data. Databases, whether serving an online transaction processing (OLTP) application or a data warehouse, typically store sensitive data inside large tables. Some examples of sensitive data include personally identifiable information (PII), non-public personal information (NPI) and intellectual property. Because such repositories store so much data and because of increasing demands for security and privacy, organizations need to ensure that data accessed by a user, either directly or through an application, is limited to the data that the user is authorized to view.

A known mechanism for addressing such requirements is to use access control mechanisms within the database or to build database objects that implement filtering capabilities. An example of using access control mechanisms within the database is to use IBM DB2 multilevel security (MLS) software allowing a database administrator to define access rules that are more granular than the normal entitlements of tables. Normal database access is defined in a way that a user is granted access to the whole table. Mechanisms such as MLS provide more granularity in that a policy can be defined to enforce that a user may see parts of the table but not the whole table. For example, a sales person from California may be entitled to see all customers in California but a sales person in Illinois cannot see data of California residents.

A second known mechanism for addressing such requirements is to use database views. Database views can be built on top of the base objects (the data table) to include processing logic that “filters out” some rows of the table so that a SELECT statement on the view yields only a subset of the data. Views can also be used to mask certain columns since IF . . . THEN . . . ELSE logic can cause some columns to be masked out as the view is computed.

There are a number of deficiencies with both known mechanisms. A main deficiency is that using such mechanisms (especially using views) requires application and/or database changes. Applications and databases are extremely complex and requiring such changes can cause long and costly projects that often fail. Most organizations view any solution that requires changes to the application as not being viable.

Also, both known mechanisms are usually associated with performance degradation. Views with complex logic are notorious for causing performance issues. In addition, the logic that controls the masking and filtering is embedded within the database and therefore true separation of duties (SoD) cannot be enforced. It is often the case that administrators, who can modify the logic, are the main users that are called out in privacy regulations. Yet further, both approaches rely on the capabilities within the database platform that may or may not exist or may not be the same in other database products and, therefore, cannot be uniformly applied across a heterogeneous data environment.

Further, both methods are performed within the database. This raises two issues that make the mechanisms undesirable. First, there is the lack of separation of duties (SoD). Because such requirements often involve the need to secure data from privileged users such as database administrators (DBAs), and because DBAs mostly have a full reign within the database, any such mechanism implemented within the database is insufficient. Secondly, any change in policy may affect application behavior and thus, the application needs to go through a strict (and lengthy) change management process.

### SUMMARY

The different illustrative embodiments provide a method, an apparatus, and a computer program product for protecting data in a database. A query to a database in a data processing system is received by a security mechanism in the data processing system that is external of the database. The query is converted to a modified query according to a security policy. The modified query is sent to the database, and a response to the modified query is returned.

### BRIEF DESCRIPTION OF THE SEVERAL VIEWS OF THE DRAWINGS

FIG. 1 is an illustrative diagram of a data processing environment in which illustrative embodiments may be implemented;

FIG. 2 is an illustration of a data processing system in accordance with an illustrative embodiment;

FIG. 3 is an illustration of an apparatus for protecting data in a database in accordance with an illustrative embodiment;

FIG. 4 is an illustration of a flowchart of a process for protecting data in a database in accordance with an illustrative embodiment; and

FIG. 5 is an illustration of a flowchart of a process for converting a query to a database to a modified query to the database in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

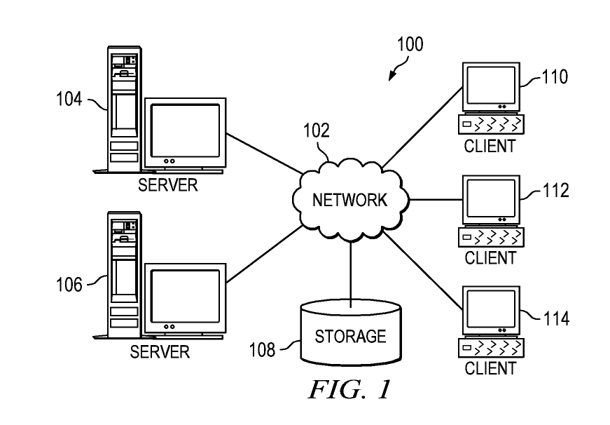

With reference now to the figures, and in particular with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a pictorial representation of a network data processing system in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

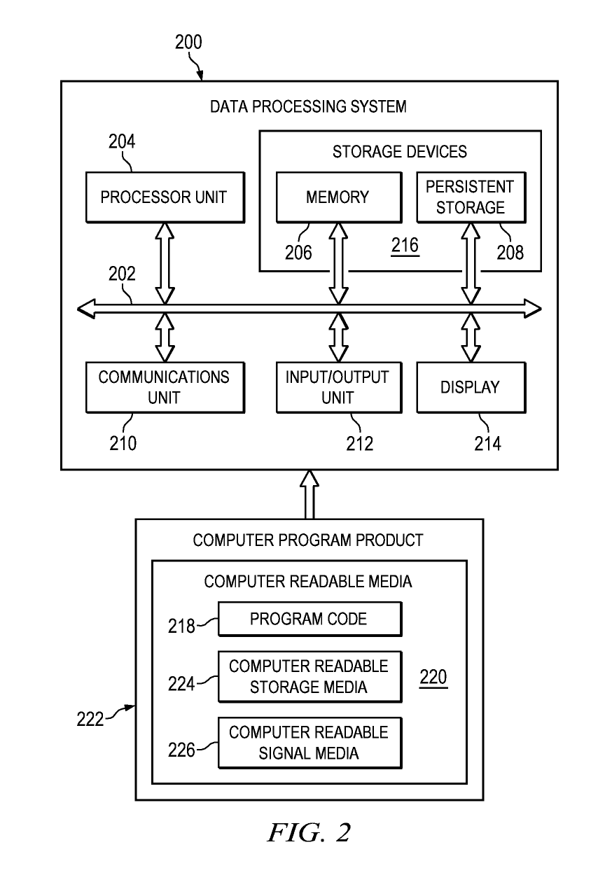

Turning now to FIG. 2, an illustration of a data processing system is depicted in accordance with an illustrative embodiment. Data processing system 200 is an example of hardware that may be used to implement computers in network data processing system 100 in FIG. 1. For example, data processing system 200 may be used to implement server computers and client computers in network data processing system 100 in FIG. 1. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these illustrative examples, computer readable storage media 224 is a non-transitory computer readable storage medium.

Alternatively, program code 218 may be transferred to data processing system 200 using computer readable signal media 226, Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some advantageous embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different advantageous embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache such as found in an interface and memory controller hub that may be present in communications fabric 202.

The different illustrative embodiments recognize and take into account a number of different considerations. For example, the different illustrative embodiments recognize and take into account that there is a need to protect data that is stored in a database in order to maintain both the privacy and the integrity of the data. The different illustrative embodiments recognize that there is a need to protect the privacy of data that is stored in a database such that, for example, a requestor seeking to access such data will only receive data that the requestor is authorized to view. The different illustrative embodiments also recognize that there is a need to protect the integrity of data that is stored in a database such that a database user can only update, insert or delete records that the user is authorized to act on. For example, a manager seeking to modify employee salaries will only be able to modify the salaries of employees within his/her department.

The different illustrative embodiments also recognize and take into account that a mechanism for protecting data in a database should not require changes to the database or to applications requesting data from the database, should not cause performance degradation, should permit separation of duties (SoD) to be enforced, and should not rely on the type of database being used.

Thus, the different illustrative embodiments provide a method, a data processing system, and a computer program product for protecting data in a database. A query to a database in a data processing system is received by a security mechanism in the data processing system that is external of the database. The query is converted to a modified query according to a security policy. The modified query is sent to the database, and a response to the modified query is returned.

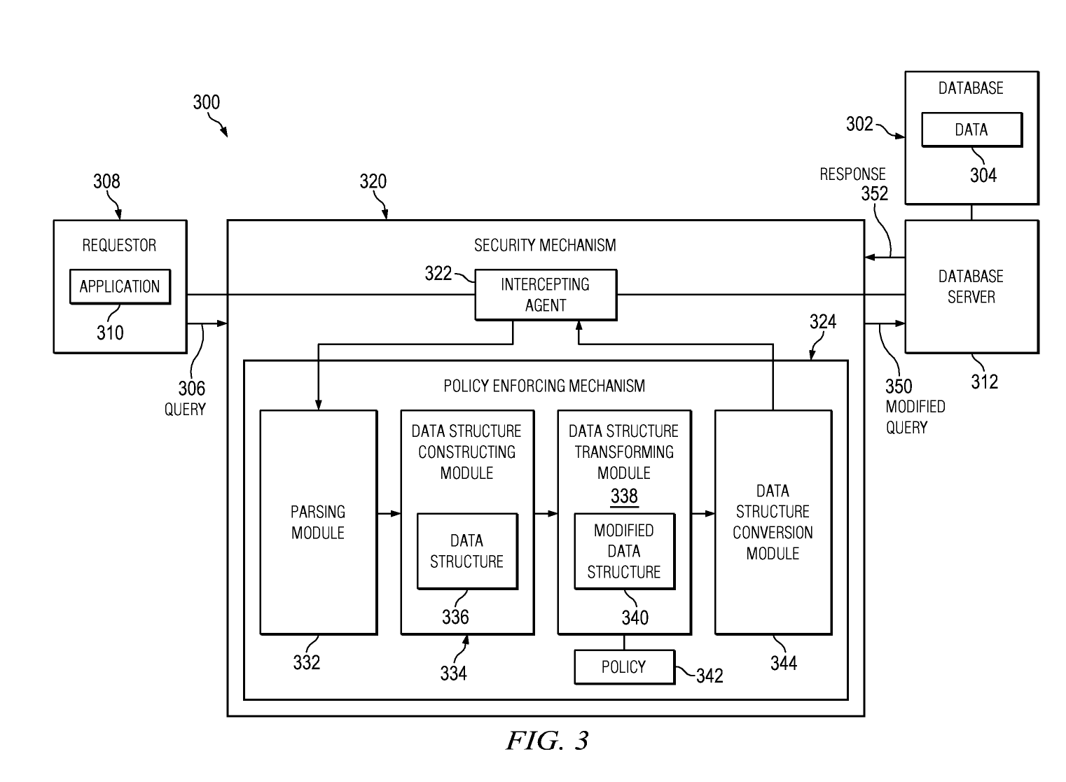

With reference now to FIG. 3, an illustration of an apparatus for protecting data in a database is depicted in accordance with an illustrative embodiment. The apparatus is generally designated by reference number 300 and includes a database 302, for example, a relational database, storing data 304, for example, relational data stored inside large tables. Database 302 is capable of receiving a request for data or a request to modify data, also referred to herein as a “query” 306 from a requestor 308. The requestor 308 may be a user from which the query is directly received by the database, or the requestor may be an application 310 through which the user sends the query. The database 302 receives a query via database server 312.

Database 302 may contain sensitive data, for example, data that a user is not authorized to view or data that a user is not authorized to modify such as by changing the data, adding data or deleting data. Examples of data that a user may be unauthorized to view include personally identifiable information (PII), non-public personal information (NPI) and intellectual property. Examples of data that a user may be unauthorized to modify include data relating to an employee's salary or data relating to an individual's credit rating. It should be understood, however, that it is not intended to limit the sensitive data to any particular type of data. In order to protect sensitive data in database 302, apparatus 300 includes an external security mechanism 320. As shown in FIG. 3, external security mechanism 320 is located external of database 302, and is positioned to intercept query 306 before the query reaches database 302. In particular, and as will be explained more fully hereinafter, external security mechanism 320 intercepts query 306 such that query 306, as sent by the requestor, does not reach the database. Instead, security mechanism 320 attaches additional modifiers to the query to form modified query 350, and modified query 350 is sent to database 302. A response 352 to the modified query 350 is then returned to the requestor 308 from the database. As will also be explained more fully hereinafter, query 306 is modified in accordance with a security policy 342 that specifies data in the database that the requestor is authorized to view and/or that specifies data that the requestor is authorized to modify to ensure that the requestor does not receive data that the requestor is not authorized to receive and to ensure that the requestor cannot modify data that the requestor is not authorized to modify.

External security mechanism 320 may, for example, be a GUARDIUM® database protection system (GUARDIUM® is a trademark of IBM Corporation of Armonk, N. Y.), although it should be understood that it is not intended to limit the external security mechanism to any particular mechanism.

Security mechanism 320 includes intercepting agent 322 and policy enforcing mechanism 324. Intercepting agent 322 receives (intercepts) query 306 from requestor 308 and “holds” the query such that the query will not yet be received by database 302. In accordance with an illustrative embodiment, intercepting agent 322 is on database server 312, and may, for example, be a kernel module that does system call interception. In accordance with an alternative illustrative embodiment, the security mechanism 320 may be put in-line on a data processing system network, for example, data processing system 100 in FIG. 1, in which case, the policy enforcing mechanism is also the intercepting agent.

Query 306 is sent from the intercepting agent 322 to the policy enforcing mechanism 324. Policy enforcing mechanism 324 includes parsing module 332, data structure constructing module 334, data structure transforming module 338 and data structure conversion module 344. Parsing module 332 parses query 306, and data structure constructing module 334 constructs a data structure 336 that expresses the query from the parsed query. Data structure transforming module 338 transforms data structure 336 into modified data structure 340. Modified data structure 340 is modified according to security policy 342 that may be built within policy enforcing mechanism 324 and that specifies data in the database that a user is authorized to view and/or that specifies data that a user is authorized to modify. Data structure conversion module 344 converts modified data structure 340 to modified query 350 that is modified according to the security policy, and modified query 350 is sent from policy enforcing mechanism 324 back to intercepting agent 322 to be sent to the database 302.

In accordance with an illustrative embodiment, data structure 336 comprises a tree data structure, for example, an AST Tree (Abstract Syntax Tree) data structure that expresses the query, although it should be understood that it is not intended to restrict the data structure to any particular type of representation of the query. The data structure transforming module 338 receives the AST Tree data structure 336 and reviews security policy 342 to determine what additional qualifications are required to ensure that the user will only receive data that the user is authorized to receive and/or to ensure that the user can only modify data that the user is authorized to modify. Based on the security policy 342, the data structure transforming module 338 transforms AST tree data structure 336 to modified AST Tree data structure 340.

In accordance with an illustrative embodiment, transforming of the AST Tree may be performed by one or both of the following two ways: 1) additional nodes are added to the AST Tree to cause more conditions to exist for the WHERE clause, and 2) nodes that are linked to the list clause are “wrapped” by additional IF nodes that, when converted back to a query, cause redaction to occur. As one example, if a table has columns of the form SELECT FIRST_NAME, LAST_NAME, DEPT, SALARY from EMP and the user is only entitled to see salaries for employees of department ENGINEERING then the query would be modified to be SELECT FIRST_NAME, LAST NAME, DEPT, IF(DEPT=‘ENGINEERING’, SAL,^{‘****’}) from EMP. As a second example, if a user only has authority over records of DEPT ‘ENGINEERING’, then the user should not be able to delete records for employees in other departments. Therefore, if a user issued a query of the form DELETE FROM EMP, it will be modified to read DELETE FROM EMP where DEPT=‘ENGINEERING’. As a third example, if a user inserts records into the table, the INSERT statement will automatically include the DEPT value even if the user did not explicitly specify it.

Modified query 350 is sent from the intercepting agent 322 to database 302. A response 352 to the modified query is then returned to requestor 308. Response 352 is a response to modified query 350 that was modified according to security policy 342 rather than a response to the original query 306. Accordingly, requestor 308 will only receive data from database 302 that the requestor is authorized to receive or be allowed to modify data that the requestor is authorized to modify.

Response 352 may be returned to requestor 308 without further manipulation, or, if desired, response 352 may be intercepted and further manipulated prior to being returned to requestor 308.

By employing external security mechanism 320 to protect data in database 302, it is not necessary to introduce changes in the database or in a requesting application. Also, there is no performance penalty because most of the work is done on a mechanism that is separate from the database. In addition, illustrative embodiments also support SoD because the security mechanism is outside the database and is agnostic to the type of database for which the security policy is being enforced.

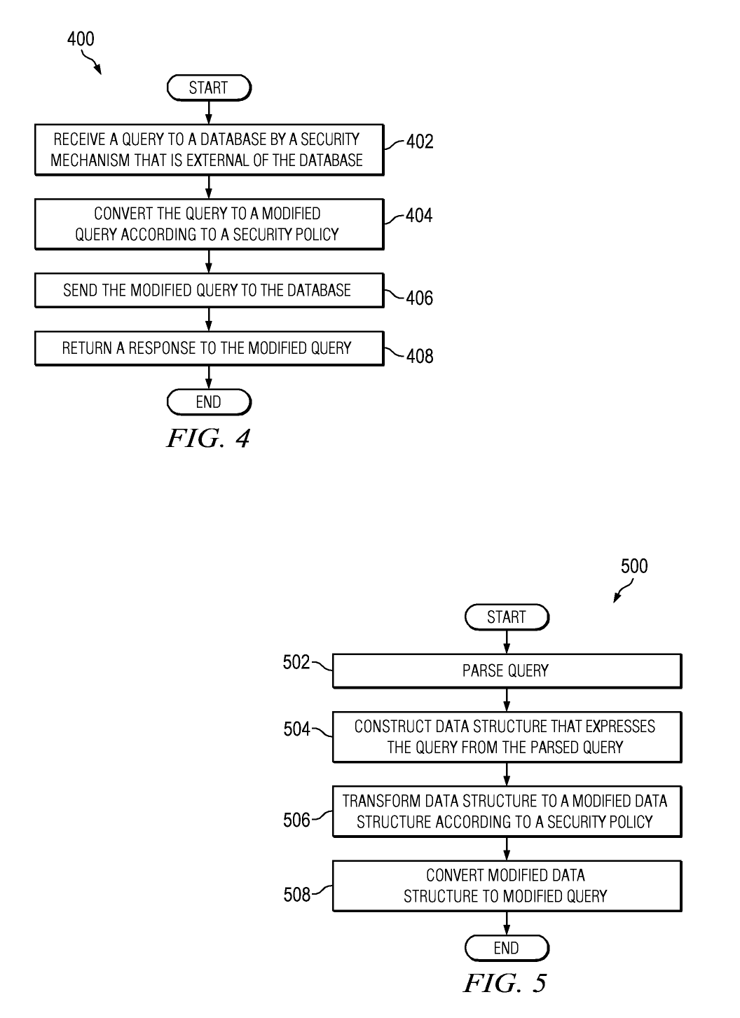

With reference now to FIG. 4, an illustration of a flowchart of a process for protecting data in a database is depicted in accordance with an illustrative embodiment. The process illustrated in FIG. 4 may be implemented using apparatus for protecting data 300 illustrated in FIG. 3. The process is generally designated by reference number 400 and may begin by receiving a query to a database in a data processing system by a security mechanism in the data processing system that is external of the database (Step 402). The query is converted to a modified query according to a security policy (Step 404), and the modified query is sent to the database (Step 406). The database returns a response to the modified query (Step 408), and the process ends. According to an illustrative embodiment, the response may be intercepted by the external security system and further manipulated before the response is returned.

With reference now to FIG. 5, an illustration of a flowchart of a process for converting a query to a database to a modified query to the database is depicted in accordance with an illustrative embodiment. The process illustrated in FIG. 5 may be implemented as Step 404 in FIG. 4. The process is generally designated by reference number 500, and may begin by parsing the query (Step 502). A data structure that expresses the query is then constructed from the parsed query (Step 504). The data structure may, for example, be a tree data structure such as an AST Tree. The data structure is then transformed to a modified data structure according to a security policy that specifies data in the database that the user is authorized to receive (view) and/or that specifies data in the database that the user is authorized to modify such as by adding, deleting or changing data (Step 506). The modified data structure may be a modified tree structure such as a modified AST Tree. The transformation may be at least one of adding at least one WHERE clause to the first data structure, adding at least one IF clause to the first data structure to cause redaction to occur when the second data structure is converted to the modified query, modifying at least one of an UPDATE clause, a DELETE clause or an INSERT clause to ensure that a user can only modify, delete or add data that the user is authorized to add, delete or modify, or modifying or adding a SELECT clause to the first data structure to prevent a user from selecting certain data. The modified data structure is then converted to modified query according to the security policy (Step 508) and the process ends.

In accordance with illustrative embodiments, a mechanism for protecting data in a database is provided that has a security mechanism that is external of the database. The mechanism does not require changes to the database or to applications requesting data from the database. The mechanism does not cause performance degradation, does not rely on the type of database being used, and permits separation of duties (SoD) to be enforced.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for protecting data in a database, comprising:
receiving a query to a database in a data processing system by a security mechanism of the data processing system that is external of the database;
converting the query to a modified query according to a security policy;
sending the modified query to the database; and
returning a response to the modified query.

2. The method of claim 1, wherein the security policy specifies at least one of data in the database that a requestor is authorized to receive and data in the database that the requestor is authorized to modify, and wherein the response to the modified query comprises at least one of data in the database that the requestor is authorized to receive and data in the database that the requestor is authorized to modify.

3. The method of claim 2, wherein converting the query to a modified query according to a security policy, comprises:
providing a first data structure that expresses the query;
transforming the first data structure to a second data structure according to the security policy; and
converting the second data structure to the modified query.

4. The method of claim 3, wherein transforming the first data structure to a second data structure according to the security policy, comprises:
adding at least one modifier too the first data structure according to the security policy.

5. The method of claim 4, wherein adding at least one modifier to the first data structure according to the security policy, comprises adding at least one IF clause to the first data structure to cause redaction to occur when the second data structure is converted to the modified query.

6. The method of claim 4, wherein adding at least one modifier to the first data structure according to the security policy, comprises modifying at least one of an UPDATE clause, a DELETE clause or an INSERT clause to ensure that the requestor can only modify, delete or add data that the requestor is authorized to add, delete or modify.

7. The method of claim 4, wherein adding at least one modifier to the first data structure according to the security policy, comprises one of modifying or adding a SELECT clause to the first data structure to prevent the requestor from selecting certain data.

8. The method of claim 3, wherein the first data structure comprises a first tree data structure and the second data structure comprises a second tree data structure.

9. The method of claim 8, wherein the first tree data structure comprises a first Abstract Syntax Tree and the second tree data structure comprises a second Abstract Syntax Tree.

10. The method of claim 2, wherein the requestor comprises one of a user and an application.

11. The method of claim 1, wherein the response to the modified query is returned to a requestor, and further comprising:
intercepting the response by the external security system before the response is returned to the requestor; and
further manipulating the response

12. A computer program product, comprising:
a computer usable storage medium having computer usable program code encoded thereon configured for protecting data in a database, the computer program product comprising:
computer usable program code configured for receiving a query to a database in a data processing system by a security mechanism of the data processing system that is external of the database;
computer usable program code configured for converting the query to a modified query according to a security policy;
computer usable program code configured for sending the modified query to the database; and
computer usable program code configured for returning a response to the modified query.

13. The computer program product of claim 12, wherein the security policy specifies at least one of data in the database that a requestor is authorized to receive and data in the database that the requestor is authorized to modify, and wherein the response to the modified query comprises at least one of data in the database that the requestor is authorized to receive and data in the database that the requestor is authorized to modify.

14. The computer program product of claim 13, wherein the computer usable program code configured for converting the query to a modified query according to a security policy, comprises:
computer usable program code configured for providing a first data structure that expresses the query;
computer usable program code configured for transforming the first data structure to a second data structure according to the security policy; and
computer usable program code configured for converting the second data structure to the modified query.

15. The computer program product of claim 14, wherein the computer usable program code configured for transforming the first data structure to a second data structure according to the security policy, comprises at least one of:
computer usable program code configured for adding at least one IF clause to the first data structure to cause redaction to occur when the second data structure is converted to the modified query;
computer usable program code configured for modifying at least one of an UPDATE clause, a DELETE clause or an INSERT clause to ensure that the requestor can only modify, delete or add data that the requestor is authorized to add, delete or modify; and
computer usable program code configured for modifying or adding a SELECT clause to the first data structure to prevent the requestor from selecting certain data.

16. The computer program product of claim 14, wherein the first data structure comprises a first tree data structure and the second data structure comprises a second tree data structure.

17. The computer program product of claim 12, and further comprising:
computer usable program code configured for intercepting the response by the external security system before the response is returned to a requestor; and
computer usable program code configured for further manipulating the response.

18. An apparatus, comprising:
a bus;
a communications unit connected to the bus;
a memory connected to the bus, wherein the memory includes a set of computer usable program code; and
a processor unit connected to the bus, wherein the processor unit executes the set of computer usable program code to perform the steps of:
receiving a query to a database in a data processing system by a security mechanism of the data processing system that is external of the database;
converting the query to a modified query according to a security policy, wherein the security policy specifies at least one of data in the database that a requestor is authorized to receive and data in the database that the requestor is authorized to modify, and wherein the response to the modified query comprises at least one of data in the database that the requestor is authorized to receive and data in the database that the requestor is authorized to modify;
sending the modified query to the database; and
returning a response to the modified query.

19. The apparatus of claim 18, wherein the processor unit executing the set of computer usable program code to perform the step of converting the query to a modified query according to a policy, comprises:
the processor executing the set of computer usable program code to perform the steps of:
providing a first data structure that expresses the query;
transforming the first data structure to a second data structure according to the security policy; and
converting the second data structure to the modified query.

20. The apparatus of claim 19, wherein the processor executing the computer usable program code to perform the step of transforming the first data structure to a second data structure according to the security policy, comprises:
the processor executing the set of computer usable program code to perform at least one of the steps of:
adding at least one IF clause to the first data structure to cause redaction to occur when the second data structure is converted to the modified query;
modifying at least one of an UPDATE clause, a DELETE clause or an INSERT clause to ensure that the requestor can only modify, delete or add data that the requestor is authorized to add, delete or modify; or
modifying or adding a SELECT clause to the first data structure to prevent the requestor from selecting certain data.
